(19) United States
(12) Patent Application Publication
(10) Pub. No.: US 2018/0044464 A1
(43) Pub. Date: Feb. 15, 2018

(54) VISCOELASTIC FLEXIBLE POLYURETHANE FOAMS BASED ON POLYETHER CARBONATE POLYOLS

(71) Applicant: Covestro Deutschland AG, Leverkusen (DE)

(72) Inventors: Bert Klesczewski, Köln (DE); Urs Rauwald, Düsseldorf-Benrath (DE); Jörg Hofmann, Krefeld (DE)

(21) Appl. No.: 15/552,841

(22) PCT Filed: Feb. 23, 2016
(86) PCT No.: PCT/EP2016/053699

§ 371 Date: Aug. 23, 2017

(30) Foreign Application Priority Data
Feb. 27, 2015 (EP) 15157033.0

(51) Int. Cl. C08G 18/40; C08G 64/34; C08G 18/76; C08G 18/44; C08G 18/48

(52) U.S. Cl. CPC C08G 18/4018; C08G 18/44; C08G 18/4816; C08G 18/7621; C08G 64/34; C08G 2101/0008

(57) ABSTRACT

The present invention relates to a method for the production of viscoelastic polyurethane foams by reacting an isocyanate component with a component which is reactive towards isocyanates, comprising ≧50 to ≦100 weight parts of at least one polyether carbonate polyol with a hydroxyl number according to DIN 53240 of ≧150 mg KOH/g to ≦300 mg KOH/g. The invention also relates to polyurethane foams produced by the method of the invention and their use.

### CROSS-REFERENCE TO RELATED APPLICATIONS

This Application is a National Phase Application of PCT/EP2016/053699, filed Feb. 23, 2016, which claims priority to European Application No. 15157033.0 filed Feb. 27, 2015, each of which is being incorporated herein by reference.

### FIELD

The present invention relates to a method for producing viscoelastic polyurethane foams, preferably viscoelastic polyurethane soft foams, by reacting an isocyanate component with a component that reacts with isocyanates and comprises at least one polyether carbonate polyol. The invention also relates to polyurethane foams produced by the method of the invention and their use.

### BACKGROUND

As part of an environmentally friendly orientation of production processes, it is generally desirable to employ starting materials based on CO₂, for example in the form of polyether carbonate polyols. One such application is for example known from WO 2014/074706 A1. It discloses viscoelastic polyurethane foams which are produced using a polyol component that contains polyether carbonate polyols in an amount of 2 to 50% by weight. The foams thus produced are characterised by a comparatively high hardness, especially if the proportion of polyether carbonate polyols is high, which is perceived as disadvantageous especially for viscoelastic flexible foams. In addition, the used polyol mixtures of the polyether carbonate polyols and the conventional polyether polyols tend to segregation, which creates problems with regard to the foam production.

### SUMMARY

The object of the present invention was to provide a way with which viscoelastic polyurethane (soft) foams can be produced using starting materials based on CO₂ which possess a satisfactory softness also for PU soft foam applications.

This object is achieved by a method for producing viscoelastic polyurethane foams by implementing a component A comprising
A1 ≧50 to ≦100 weight parts of at least one polyether carbonate polyol with a hydroxyl number from ≧150 mg KOH/g to ≦300 mg KOH/g according to DIN 53240,
A2 ≦50 to ≧0 weight parts of at least one polyether polyol with a hydroxyl number from ≧20 mg KOH/g to ≦250 mg KOH/g according to DIN 53240, wherein the polyether polyol is free from carbonate units,
A3 0.5 to 25 weight parts, based on the sum of the weight parts of components A1 and A2, water and/or physical propellants,
A4 0 to 10 weight parts, based on the sum of the weight parts of components A1 and A2, at least one antioxidant,
A5 0 to 10 weight parts, based on the sum of the weight parts of components A1 and A2, adjuvants and additives, with a component B, containing
B di- and/or polyisocyanates, wherein these are 2,4- and/or 2,6-TDI and/or modified polyisocyanates derived from 2,4- and/or 2,6-TDI or mixtures of these isocyanates with other di- and/or polyisocyanates,
   wherein the reaction of component A with component B is carried out at an isocyanate index of 70 to 130 and wherein all weight part data of the components A1 to A5 are scaled such that the sum of the weight parts A1+A2 is 100 in the composition.

### DETAILED DESCRIPTION

The invention is based on the discovery that with the use of 50 to 100 weight parts of a polyether carbonate polyol with a hydroxyl number from ≧150 mg KOH/g to ≦300 mg KOH/g according to DIN 53240, soft viscoelastic polyurethane foams can be produced despite the high amount of polyether carbonate polyols. That is, the polyurethane (soft) foams produced according to the invention do not show the increase in hardness with an increasing proportion of polyether carbonate polyols known from the state of the art. The inventive high application amount of polyether carbonate polyols is also connected with a comparatively high incorporation amount of carbon dioxide into the foam, which results in the aforementioned environmental advantages.

For the production of the polyurethane foams, the reaction components are reacted using the basically known one-step method, wherein often mechanical devices are used, e.g. as described in EP-A 355 000. Details of processing equipment which is also suitable according to the invention are described in the Kunststoff-Handbuch, Volume VII, edited by Vieweg and Hoechtlen, Carl-Hanser-Verlag, Munich 1993, e.g. on pages 139 to 265.

The polyurethane foams produced with the method according to the invention are preferably in the form of polyurethane soft foams and can be prepared as mould or as block foams, preferably as block foams. Other objects of the invention are a polyurethane foam produced according to these methods, a polyurethane soft block foam or polyurethane soft form foam produced according to these methods and the use of the polyurethane soft foams for the production of form parts as well as the form parts themselves.

A viscoelastic polyurethane foam or polyurethane soft foam is considered to be a foam which has a low ball rebound elasticity according to DIN EN ISO 8307:2007. According to that, a ball is dropped on a foam test body from a defined height and the height in which the ball rebounds against the fall direction is measured. The rebound height is put in a percentage relation to the fall height. A low percentage value indicates a low rebound resilience. Ideally, the ball does not measurably rebound after its impact, which means that the ball rebound elasticity is 0%. In an advantageous embodiment of the method according to the invention, a viscoelastic polyurethane foam or polyurethane soft foam having a ball rebound elasticity according to DIN EN ISO 8307:2007 of 0% to 20%, in particular of 0% to 15%, preferably 0% to 10% or even 0% to 8% is obtained. Also preferred are polyurethane foams or polyurethane soft foams with a ball rebound elasticity according to DIN EN ISO 8307:2007 of 2% to 20%, in particular of 2% to 15%.

A particularly preferred polyurethane foam or polyurethane soft foam which is obtainable by the method according to the invention is one for whose production a polyether carbonate polyol A1 having a hydroxyl number from >250 mg KOH/g to <300 mg KOH/g according to DIN 53240 is used. Such a polyurethane foam or polyurethane soft foam is characterised by particularly good viscoelastic characteristics, i.e. a particularly low ball rebound elasticity according to DIN EN ISO 8307:2007. The used polyether carbonate polyol A1 particularly has an average OH functionality of 2.5 to 3.5, preferably 2.7 to 3.3, 2.9 to 3.1 being particularly preferred.

A further object of the present invention concerns the use of a polyol component comprising or consisting of at least one polyether carbonate polyol A1 with a hydroxyl number according to DIN 53240 of ≧150 mg KOH/g to ≦300 mg KOH/g and at least one polyether polyol A2 with a hydroxyl number according to DIN 53240 of ≧20 mg KOH/g to ≦250 mg KOH/g, free from carbonate units for the production of viscoelastic polyurethane foams, wherein the polyol component contains ≧50 to ≦100 weight % of the polyether carbonate polyol A1 and ≦50 to ≧0 weight % of the polyether polyol A2. It is particularly advantageous if the polyol component does not contain any other organic polyol than the polyether carbonate polyol A1 or if no further organic polyols which do not fall under the definition of the polyether carbonate polyol A1 are used for the production of the polyurethane foams.

Also for this use according to the invention, it is advantageous to use a polyether carbonate polyol A1 with a hydroxyl number according to DIN 53240 of >250 mg KOH/g to ≦300 mg KOH/g, as this results in a polyurethane foam or polyurethane soft foam with particularly good viscoelastic characteristics. Again, the used polyether carbonate polyol A1 particularly has an average OH functionality of 2.5 to 3.5, preferably 2.7 to 3.3, 2.9 to 3.1 being particularly preferred.

The indefinite term “a(n)” generally means “at least one” in the sense of “one or more”. The skilled person will understand that, depending on the situation, not the indefinite article but the definite article “one” in the sense of “1” must be meant or the indefinite article “a(n)” also the definite article “one” (1) in one embodiment.

The term “polyurethane (soft) foam” is short for a polyurethane foam of any kind, in particular polyurethane hard foam and polyurethane soft foam.

In the following, the components used in the method according to the invention will be described in more detail.

Component A1

Component A1 comprises a polyether carbonate polyol with a hydroxyl number (OH number) from ≧150 mg KOH/g to ≦300 mg KOH/g, preferably from ≧170 mg KOH/g to ≦290 mg KOH/g, particularly preferred from ≧180 mg KOH/g to ≦280 mg KOH/g according to DIN 53240. It is also preferred that the polyether carbonate polyol A1 has a hydroxyl number according to DIN 53240 of >250 mg KOH/g to ≦300 mg KOH/g. The aforementioned polyether carbonate polyols can for example be obtained by copolymerisation of ≧2 weight % to ≦30 weight % of carbon dioxide and ≧70 weight % to ≦98 weight % of one or more alkylene oxides in the presence of one or more H-functional starter molecules with an average functionality of ≧1 to ≦6, preferably of ≧1 and ≦4, ≧2 and ≦3 being particularly preferred. “H-functional” in the sense of the invention shall mean a starter compound which has H atoms which are active towards alkoxylation. For example, trimethylol propane, glycerol and/or propylene glycol and/or sorbitol can be used as hydroxy functional starter molecule. The hydroxyl number can be determined according to DIN 53240.

Preferably, the copolymerisation of carbon dioxide and one or more alkylene oxides is in the presence of at least one multi metal cyanide catalyst or double metal cyanide catalyst (DMC catalyst).

Preferably, the polyether carbonate polyols used according to the invention also have ether groups between the carbonate groups, which is schematically shown in formula (I). In the scheme according to formula (I), R is an organic residue such as alkyl, alkylaryl or aryl, which may also contain heteroatoms such as O, S, Si, and so on, wherein E and F are integers. The polyether carbonate polyol shown in the scheme according to formula (I) shall only mean that blocks with the shown structure in the polyether carbonate polyol can be found again, but the sequence, number and length of the blocks may vary and is not restricted to the polyether carbonate polyol shown in formula (I). With regard to formula (I), this means that the e/f ratio is preferably 2:1 to 1:20, especially preferred from 1.5:1 to 1:10.

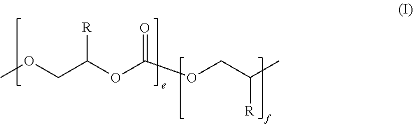

The proportion of incorporated CO₂ (“units derived from carbon dioxide”) in a polyether carbonate polyol can be determined by the evaluation of characteristic signals in the ¹H—NMR spectrum. The following example illustrates the determination of the proportion of units derived from carbon dioxide in a CO₂/propyleneoxide-polyether carbonate polyol started on 1,8-octanediol.

The proportion of incorporated CO₂ in a polyether carbonate polyol as well as the relation of propylene carbonate to polyether carbonate polyol can be determined by ¹H—NMR (a used device is from the company Bruker, DPX 400, 400 MHz; pulse programme zg30, waiting period d1: 10s, 64 scans). Each sample is dissolved in deuterated chloroform. The relevant resonances in ¹H—NMR (based on TMS=0 ppm) are as follows:

Cyclic carbonate (which was formed as by-product) with a resonance at 4.5 ppm; carbonate, resulting from carbon dioxides incorporated in the polyether carbonate polyol with resonances at 5.1 to 4,8 ppm; non-abreacted propyleneoxide (PO) with a resonance at 2.4 ppm; polyether polyol (i.e. without incorporated carbon dioxide) with resonances at 1.2 to 1.0 ppm; 1,8 octanediol incorporated as starter molecule (if available) with a resonance at 1.6 to 1.52 ppm.

The molar content of the carbonate incorporated in the polymer in the reaction mixture is calculated as follows according to formula (II), wherein the following abbreviations are used:

F(4.5)=resonance area at 4.5 ppm for cyclic carbonate (corresponds to one H atom)

F(5.1-4.8)=resonance area at 5.1-4.8 ppm for polyether carbonate polyol and one H atom for cyclic carbonate.

F(2.4)=resonance area at 2.4 ppm for free, non-abreacted PO

F(1.2-1.0)=resonance area at 1.2-1.0 ppm for polyether polyol

F(1.6-1.52)=resonance area at 1.6 to 1.52 ppm for 1,8 octanediol (starter), if available.

Taking into account the relative intensities, the polymer-bound carbonate (“linear carbonate” LC) in the reaction mixture was converted into mol % according to the following formula (II):

$$LC = \frac{F ( 5 , 1 - 4 , 8 ) - F ( 4 , 5 )}{\begin{matrix}F ( 5 , 1 - 4 , 8 ) + F ( 2 , 4 ) + 0 , 33 * \\ F ( 1 , 2 - 1 , 0 ) + 0 , 25 * F ( 1 , 6 - 1 , 52 )\end{matrix}} * 100 \qquad ( II )$$

The weight proportion (in weight %) of the polymer-bound carbonate (LC′) in the reaction mixture was calculated according to formula (III):

$${LC}^{′} = \frac{[ F ( 5 , 1 - 4 , 8 ) - F ( 4 , 5 ) ] * 102}{N} * 100 \% \qquad ( III )$$

This results in the value for N (“denominator” N) according to formula (IV) as follows:

N=[F(5,1−4,8)−F(4,5)]*102+F(4,5)*102+F(2,4)*58+0,33*F(1,2−1,0)*58+0,25*F(1,6−1,52)*146 (IV)

The factor 102 results from the sum of the molar masses of CO₂ (molar mass 44 g/mol) and of propylene oxide (molar mass 58 g/mol), the factor 58 results from the molar mass of propylene oxide and the factor 146 results from the molar mass of the used starter 1,8-octanediol (if available).

The weight proportion (in weight %) of cyclic carbonate (CC′) in the reaction mixture was calculated according to formula (V):

$${CC}^{′} = \frac{F ( 4 , 5 ) * 102}{N} * 100 \% \qquad ( V )$$

wherein the value of N is calculated according to formula (IV).

In order to calculate the composition based on the polymer proportion (consisting of polyether polyol, which was produced from the starter and of propylene oxide during the activation steps under conditions free from CO₂, and polyether carbonate polyol produced from the starter, propylene oxide and carbon dioxide during the activation steps occurring in the presence of CO₂ and during copolymerisation) from the values of the composition of the reaction mixture, the non-polymer components of the reaction mixture (i.e. cyclic propylene carbonate and possibly available, non-reacted propylene oxide) were eliminated by calculation. The weight proportion of the carbonate repeat units in the polyether carbonate polyol was converted into a weight proportion of carbon dioxide using the factor F=44/(44+58). The indication of the CO₂ content in the polyether carbonate polyol is normalised to the proportion of the polyether carbonate polyol molecule which was formed during copolymerisation and possibly during the activation steps in the presence of CO₂ (e.g. the proportion of the polyether carbonate polyol molecule resulting from the starter (1,8-octanediol, if available) and from the reaction of the starter with epoxide which was added under CO2-free conditions was not considered).

For example, the production of polyether carbonate polyols according to A1 comprises:

(α) the presentation of a H-functional starter substance or a mixture of at least two H-functional starter substances and optionally the removal of water and/or other readily volatile compounds by elevated temperature and/or reduced pressure (“drying”), wherein the DMC catalyst of the H-functional starter substance or the mixture of at least two H-functional starter substances is added before or after drying,

(β) a partial amount (based on the total amount of the alkenyl oxides used for activation and copolymerisation) of one or more alkenyl oxides is added to the mixture resulting from step (α) for activation, wherein this addition of a partial amount of alkenyl oxides can possibly occur in the presence of CO₂, and wherein then the temperature peak (“hotspot”) occurring due to the following exothermic chemical reaction and/or a pressure drop in the reactor are respectively awaited, and wherein step (β) for activation can also occur several times,

(β) one or more of the alkenyl oxides and carbon dioxide are added to the mixture resulting from step (β), wherein the alkenyl oxides used in step (β) can be the same as or different from the alkenyl oxides used in step (γ).

Generally, alkenyl oxides (epoxides) with 2 to 4 carbon atoms can be used for the production of the polyether carbonate polyols A1. The alkenyl oxides with 2 to 24 carbon atoms are for example one or more compounds selected from the group consisting of ethylene oxide, propylene oxide, 1-butene oxide, 2,3-butene oxide, 2-methyl-1,2-propene oxide (isobutene oxide), 1-pentene oxide, 2,3-penteneoxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrole oxide, methylstyrole oxide, pinene oxide, one or more times epoxy-enhanced fats as mono-, di- and triglycerides, epoxy-enhanced fat acids, C₁-C₂₄ esters of epoxy-enhanced fat acids, epichlorohydrin, glycidol, and derivates of the glycidol, such as methylglycidyl ethers, ethylglycidyl ethers, 2-ethylhexylglycidyl ethers, allylglycidyl ethers, glycidylmethacrylate and epoxy-functional alkoxy silanes such as 3-glycidyloxypropyltrimethoxysilane, 3-glycidyloxypropyltriethoxysilane, 3-glycidyloxypropyltripropoxysilane, 3-glycidyloxypropylmethyldimethoxysilane, 3-glycidyloxypropylethyldiethoxysilane, 3-glycidyloxypropyltriisopropoxysilane.

Preferably, ethylene oxide and/or propylene oxide and/or 1,2 butylene oxide are used as alkylene oxides, propylene oxide being particularly preferred.

In a preferred embodiment of the invention, the amount of ethylene oxide in the total amount of propylene oxide and ethylene oxide used is ≧0 and ≦90 weight %, preferably ≧0 and ≦50 weight % and particularly preferably free from ethylene oxide.

Compounds with H-atoms which are active for alkoxylation can be used as suitable H-functional starter substances. Groups with active H-atoms which are active for alkoxylation are for example —OH, —NH₂ (primary amines), —NH— (secondary amines), —SH and —CO₂H, —OH and —NH₂ being preferred, —OH being particularly preferred. For example, one or more compounds selected from the group consisting of water, monovalent or polyvalent alcohols, polyvalent amines, polyvalent thiols, amino alcohols, thio alcohols, hydroxy esters, polyether polyols, polyester polyols, polyesterether polyols, polyether carbonate polyols, polycarbonate polyols, polycarbonates, polyethylene imines, polyether amines (e.g. so-called Jeffamines® from Huntsman, such as D-230, D-400, D-2000, T-403, T-3000, T-5000 or corresponding products from BASF, such as polyetheramine D230, D400, D200, T403, T5000), polytetrahydrofuranes (e.g. PolyTHF® from BASF, such as PolyTHF® 250, 650S, 1000, 1000S, 1400, 1800, 2000), polytetrahydrofurane amines (BASF product polytetrahydrofurane amine 1700), polyetherthiols, polyacrylate polyols, castor oil, the mono- or diglyceride of ricinoleic acid, monoglycerides of fat acids, chemically modified mono-, di- and/or triglycerides of fat acids, and C1-C24 alkyl fat acid esters which on average contain at least 2 OH groups per molecule, are used as H-functional starter substance. The C1-C24 alkyl fat acid esters which on average contain at least 2 OH groups per molecule are for example trade products such as Lupranol Balance® (BASF AG), Merginol® types (Hobum Oleochemicals GmbH), Sovermol® types (Cognis Deutschland GmbH & Co. KG) and Soyol® types (USSC Co.).

Alcohols, amines, thiols and carboxylic acids can be used as monofunctional starter compounds. The following can be used as monofunctional alcohols: methanol, ethanol, 1-propanol, 2-propanol, 1-butanol, 2-butanol, t-butanol, 3-buten-1-ol, 3-butin-1-ol, 2-methyl-3-buten-2-ol, 2-methyl-3-butin-2-ol, propapgyl alcohol, 2-methyl-2-propanol, 1-t-butoxy-2-propanol, 1-pentanol, 2-pentanol, 3-pentanol, 1-hexanol, 2-hexanol, 3-hexanol, 1-heptanol, 2-heptanol, 3-heptanol, 1-octanol, 2-octanol, 3-octanol, 4-octanol, phenol, 2-hydroxybiphenyl, 3-hydroxybiphenyl, 4-hydroxybiphenyl, 2-hydroxypyridin, 3-hydroxypyridin, 4-hydroxypyridin. The following monofunctional amines can be used: butylamine, t-butylamine, pentylamine, hexylamine, aniline, aziridine, pyrrolidine, piperidine, morpholine. The following can be used as monofunctional thiols: ethanethiol, 1-propanethiol, 2-propanethiol, 1-butanethiol, 3 -methyl-1-butanethiol, 2-butene-1-thiol, thiophenol. The following monofunctional carboxylic acids shall be stated: formic acid, acetic acid, propionic acid, butyric acid, fatty acids such as stearic acid, palmitic acid, oleic acid, linoleic acid, linolenic acid, benzoic acid, acrylic acid.

Polyvalent alcohols suitable as H-functional starter substances are for example bivalent alcohols (such as ethylene glycol, diethylene glycol, propylene glycol, dipropylene glycol, 1,3-propanediol, 1,4-butanediol, 1,4-butenediol, 1,4-butinediol, neopentyl glycol, 1,5-pentantane diol, methylpentane diols (such as 3-methyl-1,5-pentane diol), 1,6-hexane diol; 1,8-octane diol, 1,10-decane diol, 1,12-dodecane diol, bis-(hydroxymethyl)-cyclohexanes (such as 1,4-bis-(hydroxymethyl)cyclohexane), tri ethylene glycol, tetraethylene glycol, polyethylene glycols, dipropylene glycol, tripropylene glycol, polypropylene glycols, dibutylene glycol and polybutylene glycols); trivalent alcohols (such as trimethylol propane, glycerin, trishydroxyethylisocyanurate, castor oil); tetravalent alcohols (such as pentaerythritol); polyalcohols (such as sorbitol, hexitol, saccharose, starch, starch hydrolysates, cellulose, cellulose hydrolysates, hydroxy-functionalised fats and oils, in particular castor oil) and all modified products of the aforementioned alcohols with different amounts of E-caprolactone. Trivalent alcohols such as trimethylpropane, glycerin, trishydroxyethylisocyanurate and castor oil can be used in mixtures of H-functional starters as well.

The H-functional starter substances can also be selected from the substance class of the polyether polyols, in particular the ones with a molecular weight Mₙ in the range of 100 to 4000 g/mol, preferably 250 to 2000 g/mol. Polyether polyols which are composed of repeating ethylene oxide and propylene oxide units are preferred, preferably with an amount of 35 to 100% propylene oxide units, particularly preferred with an amount of 50 to 100% propylene oxide units. These can be statistical copolymers, gradient copolymers, alternating or block copolymers from ethylene oxide and propylene oxide. Suitable polyether polyols, consisting of repeating propylene oxide and/or ethylene oxide units, are for example the Desmophen®, Acclaim®, Arcol®, Baycoll®, Bayfill®, Bayflex®, Baygal®, PET® and polyether polyols from Bayer MaterialScience AG (such as Desmophen® 3600Z, Desmophen® 1900U, Acclaim® Polyol 2200, Acclaim® Polyol 40001, Arcol® Polyol 1004, Arcol® Polyol 1010, Arcol® Polyol 1030, Arcol® Polyol 1070, Baycoll® BD 1110, Bayfill® VPPU 0789, Baygal® K55, PET® 1004, Polyether® S180). Further suitable homo polyethylene oxides are for example the Pluriol® E brands from BASF SE, suitable homo polypropylene oxides are for example the Pluriol® P brands from BASF SE, suitable mixed copolymers from ethylene oxide and propylene oxide are for example the Pluronic® PE or Pluriol® RPE brands from BASF SE.

The H-functional starter substances can also be selected from the substance class of the polyester polyols, in particular the ones with a molecular weight Mn in the range of 200 to 4500 g/mol, preferably 400 to 2500 g/mol. Polyesters which are at least difunctional are used as polyester polyols. Polyester polyols preferably consist of alternating acid and alcohol units. For example, succinic acid, maleic acid, maleic anhydride, adipic acid, phthalic anhydride, phthalic acid, isophthalic acid, terephthalic acid, tetrahydrophthalic acid, tetrahydrophthalic anhydride, hexahydrophthalic anhydride or mixtures of the stated acids and/or anhydrides are used as acid components. For example, ethanediol, 1,2-propanediol, 1,3-propanediol, 1,4-butanediol, 1,5-pentanediol, neopentyl glycol, 1,6-hexanediol, 1,4-bis-(hydroxymethyl)-cyclohexane, diethylene glycol, dipropylene glycol, trimethylolpropane, glycerin, pentaerythritol or mixtures of the stated alcohols are used as alcohol components. If bivalent or polyvalent polyether polyols are used as alcohol component, one obtains polyester ether polyols which can also serve as starter substances for the production of polyether carbonate polyols. If polyether polyols are used for the production of the polyester ether polyols, polyether polyols with a number average molecular weight Mₙ of 150 to 2000 g/mol are preferred. Further, polycarbonate polyols (such as polycarbonate diols) can be used as H-functional starter substances, in particular such with a molecular weight Mn in the range of 150 to 4500 g/mol, preferably 500 to 2500, which are for example produced by the reaction of phosgene, dimethylcarbonate, diethylcarbonate or diphenylcarbonate and di- and/or polyfunctional alcohols or polyester polyols or polyether polyols. Examples of polycarbonate polyols can be found in EP-A 1359177, for example. For example, the Desmophen® C types from Bayer MaterialScience AG, e.g. Desmophen® C 1100 or Desmophen® C 2200, can be used as polycarbonate diols.

Polyethercarbonate polyols can also be used as H-functional starter substances. In particular, polyether carbonate polyols produced according to the method described hereabove are used. For this purpose, these polyether carbonate polyols used as H-functional starter substances are previously produced in a separate reaction step.

Preferred H-functional starter substances are alcohols of the general formula (VI),

HO—(CH₂)ₓ—OH (VI)

wherein x is a number from 1 to 20, preferably an even number from 2 to 20. Examples of alcohols according to formula (V) are ethylene glycol, 1,4-butane diol, 1,6-hexane diol, 1,8-octanediol, 1,10-decanediol and 1,12-dodecanediol. Further preferred H-functional starter substances are neopentyl glycol, trimethylol propane, glycerin, pentaerythritol, reaction products of the alcohols according to formula (V) with E-caprolactone, e.g. reaction products of trimethylol propane with E-caprolactone, reaction products of glycerin with E-caprolactone, and reaction products of pentaerythritol with E-caprolactone. Further, water, diethylene glycol, dipropylene glycol, castor oil, sorbitol and polyether polyols, consisting of repeating polyalkylene oxide units, are preferably used as H-functional starter substances.

One or more compounds selected from the group consisting of ethylene glycol, propylene glycol, 1,3-propanediol, 1,3-butanediol, 1,4-butanediol, 1,5-pentanediol, 2-methylpropan-1,3-diol, neopentyl glycol, 1,6-hexane diol, diethylene glycol, dipropylene glycol, glycerin, trimethylolpropane, di- and trifunctional polyether polyols, wherein the polyether polyol consists of a di- or tri-H-functional starter substance and propylene oxide or a di- or tri-H-functional starter substance, propylene oxide and ethylene oxide, are particularly preferred as H-functional starter substances. The polyether polyols preferably have a number average molecular weight Mn in the range of 62 to 4500 g/mol and in particular a number average molecular weight Mn in the range of 62 to 3000 g/mol, a molecular weight of 62 to 1500 g/mol is particularly preferred. Preferably, the polyether polyols have a functionality from ≧2 to ≦3.

In a preferred embodiment of the invention, the polyether carbonate polyol A1 can be obtained through the accumulation of carbon dioxide and alkylene oxides on H-functional starter substances using multi metal cyanide catalysts or double metal cyanide catalysts (DMC catalysts). The production of polyether carbonate polyols through the accumulation of alkylene oxides and CO₂ on H-functional starter substances using DMC catalysts is known from EP-A 0222453, WO-A 2008/013731 and EP-A 2115032, for example.

Generally, DMC catalysts are known from the state of the art for the homopolymerisation of epoxides (see, e.g., U.S. Pat. No. 3,404.109, U.S. Pat. No. 3,829,505, U.S. Pat. No. 3,941,849 and U.S. Pat. No. 5,158,922). DMC catalysts, which are e.g. described in U.S. Pat. No. 5,470,813, EP-A 700 949, EP-A 743 093, EP-A 761 708, WO-A 97/40086, WO-A 98/16310 and WO-A 00/47649, possess a very high activity in the homopolymerisation of epoxides and enable the production of polyether polyols and/or polyether carbonate polyols at very low catalyst concentrations (25 ppm or less). A typical example are the highly active DMC catalysts described in EP-A 700 949, which, apart from a double metal cyanide compound (e.g. zinc hexacyanocobaltate(III)) and an organic complex ligand (e.g. t-butanol), also contain a polyether with a number average molecular weight Mn greater than 500 g/mol.

The DMC catalyst is mostly used in an amount of ≦1 weight %, preferably in an amount of ≦0.5 weight %, particularly preferably in an amount of ≦500 ppm and in particular in an amount of ≦300 ppm, respectively based on the weight of the polyether carbonate polyol.

In a preferred embodiment of the invention, the polyether carbonate polyol A1 has a content of carbonate groups (“units derived from carbon dioxide”), calculated as CO₂, of ≧2.0 and ≦30.0 weight %, preferably of ≧5.0 and ≦28.0 weight % and particularly preferably of ≧10.0 and ≦25.0 weight %.

In a further embodiment of the method of the invention, the one or the more polyether carbonate polyols according to A1 have a hydroxyl number of ≧150 mg KOH/g to ≦300 mg KOH/g and can be obtained through copolymerisation of ≧2,0 weight % to ≦30.0 weight % of carbon dioxide and ≧70 weight % to ≦98 weight % of propylene oxide in the presence of a hydroxy-functional starter molecule such as trimethylolpropane and/or glycerin and/or propylene glycol and/or sorbitol. The hydroxyl number can be determined according to DIN 53240.

According to a further preferred embodiment of the method of the invention, a polyether carbonate polyol A1 is used which has blocks according to formula (I) with a ratio e/f of 2:1 to 1:20, in particular of 1.5:1 to 1:10.

Within the framework of the method of the invention, it is preferred that component A contains ≧55 to ≦100 weight parts of the polyether carbonate polyol A1 and ≦45 to ≧0 weight parts of the polyether polyol A2, in particular ≧60 to ≦100 weight parts of the polyether carbonate polyol A1 and ≦40 to ≧0 weight parts of the polyether polyol A2.

In a further embodiment of the invention, 100 weight parts of component A1, 0 weight parts of component A2 and, apart from A1, no further organic polyols are used.

In a further embodiment of the method of the invention, component A contains ≧50 to <100 weight parts of the polyether carbonate polyol A1 and ≦50 to >0 weight parts of the polyether polyol A2, preferably ≧55 to <100 weight parts of the polyether carbonate polyol A1 and ≦45 to >0 weight parts of the polyether polyol A2, particularly preferably ≦60 to <100 weight parts of the polyether carbonate polyol A1 and ≦40 to >0 weight parts of the polyether polyol A2, ≧80 to <100 weight parts of the polyether carbonate polyol A1 and ≦20 to <0 weight parts of the polyether polyol A2 being particularly preferred and ≧95 to <100 weight parts of the polyether carbonate polyol A1 and ≦5 to >0 weight parts of the polyether polyol A2 being even more preferred.

Within the framework of the present invention, it is particularly preferred that the polyether carbonate polyol A1 has an average OH-functionality of 2.5 to 3.5, in particular of 2.7 to 3.3, preferably of 2.9 to 3.1, 2.95 to 3.05 being further preferred, about 3.0 being particularly preferred. Polyether carbonate polyols with such OH-functionalities and the hydroxyl numbers according to the invention provide particularly soft viscoelastic polyurethane foams even if high amounts of polyether carbonate polyols are used.

Component A2

Component A2 comprises polyether polyols with a hydroxyl number according to DIN 53240 of ≧20 mg KOH/g to ≦250 mg KOH/g, preferably of ≧20 mg KOH/g to ≦112 mg KOH/g, and particularly preferably of ≧20 mg KOH/g to ≦80 mg KOH/g and is free from carbonate units. The compounds according to A2 can be produced by catalytic addition of one or more alkylene oxides to H-functional starter compounds.

Alkylene oxides with 2 to 24 carbon atoms can be used as alkylene oxides (epoxides). The alkenyl oxides with 2 to 24 carbon atoms are for example one or more compounds selected from the group consisting of ethylene oxide, propylene oxide, 1-butene oxide, 2,3-butene oxide, 2-methyl-1,2-propene oxide (isobutene oxide), 1-pentene oxide, 2,3-penteneoxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrole oxide, methylstyrole oxide, pinene oxide, one or more times epoxy-enhanced fats as mono-, di- and triglycerides, epoxy-enhanced fat acids, C1-C24 esters of epoxy-enhanced fat acids, epichlorohydrin, glycidol, and derivates of the glycidol, such as methylglycidyl ethers, ethylglycidyl ethers, 2-ethylhexylglycidyl ethers, allylglycidyl ethers, glycidylmethacrylate and epoxy-functional alkoxy silanes such as 3-glycidyloxypropyltrimethoxysilane, 3-glycidyloxypropyltriethoxysilane, 3 -glycidyloxypropyltripropoxysilane, 3-glycidyloxypropylmethyldimethoxysilane, 3-glycidyloxypropylethyldiethoxysilane, 3 -glycidyloxypropyltriisopropoxysilane. Preferably, ethylene oxide and/or propylene oxide and/or 1,2 butylene oxide are used as alkylene oxides. The use of excess propylene oxide and/or 1,2-butylene oxide is particularly preferred. The alkenyl oxides can be added to the reaction mixture separately, in a mixture or subsequently. It can be statistical or block copolymers. If the alkylene oxides are dosed in a subsequent manner, the produced products (polyether polyols) contain polyether chains with block structures.

The H-functional starter compounds have functionalities from ≧2 to ≦6 and are preferably hydroxy functional (OH functional). Examples of hydrofunctional starter compounds are propylene glycol, ethylene glycol, diethylene glycol, dipropylene glycol, 1,2-butanediol, 1,3-butanediol, 1,4-butanediol, hexanediol, pentanediol, 3-methyl-1,5-pentanediol, 1,12-dodecanediol, glycerin, trimethylolpropane, triethanoleamin, pentaerythritol, sorbitol, saccharose, hydrochinone, brenzcatechin, resorcin, bisphenol F, bisphenol A, 1,3,5-trihydroxybenzol, methylol group-containing condensates of formaldehyde and phenol or melamin or urea. 1,2-propylene glycol and/or glycerin and/or trimethylol propane and/or sorbitol are preferably used as starter compound.

The polyether polyols according to A2 preferably have a content of ≧0 to ≦40 weight %, particularly preferably ≧0 to ≦25 weight % of ethylene oxide.

Component A3

0.5 to 25 weight parts, preferably 1.0 to 15 weight parts, particularly preferably 1.5 to 10 weight parts, based on the sum of the weight parts of components A1 and A2, water and/or physical propellants, are used as component A3. For example, carbon dioxide and/or highly volatile organic substances are used as propellants. Preferably, water is used as component A3.

Component A4

Antioxidants which can be used for the production of polyurethane soft foams are generally known to the person skilled in the art. Such compounds are for example described in EP-A 1874853, G. Oertel (editor): “Kunststoff-Handbuch”, volume VII, Carl-Hanser-Verlag, Munich, Vienna 1993, chapter 3.4.8 or in Ullmanns' Encyclopedia of Industrial Chemistry Peter P. Klemchuck, 2012, Vol. 4, p. 162 ff, Wiley VCH.

According to a preferred embodiment of the method of the invention, component A4 comprises an antioxidant A4.1 which is free from compounds with amino groups and an antioxidant A4.2 which comprises at least one compound with one or more amino groups.

In a further advantageous embodiment of the method of the invention, component A4, as component A4.1, contains 0.02-5.0 weight parts, based on the sum of the weight parts of components A1 and A2, of an antioxidant which is free from amino groups and, as component A4.2, 0.02-5.0 weight parts, based on the sum of the weight parts of components A1 and A2, of an antioxidant which comprises at least one compound with one or more amino groups, wherein the total content of component A4 is in particular 0.04-10.0 weight parts, based on the sum of the weights parts of components A1 and A2.

In the method of the invention, the antioxidant A4.1 and A4.2 can also be contained in a respective amount of 0.05-1.5 weight parts, based on the sum of the weight parts of components A1 and A2, wherein the total content of component A4 is in particular 0.1-3.0 weight parts, based on the sum of the weight parts of components A1 and A2.

Antioxidants A4.1 which are free from amino groups comprise compounds, containing
i) phenol derivatives
ii) lactone, in particular benzofuran-2-on-derivatives
iii) phosphorus derivatives,
and any mixtures of these compounds.

Compounds containing phenol derivatives i) are for example 2,6-di-(t-butyl)-p-cresol (BHT), tetrakis[methylene(3,5-di-t-butyl-4-hydroxyhydrocinnamat)]methane, 2,2′-methylenebis-(4-methyl-6-t-butylphenol), 2,6-di-t-butyl-4-methylphenol, N,N′-1,6-hexamethylene-bis-3-(3,5-di-t-butyl-4-hydroxyphenyl)propionamide, alkyl-3-(3,5-di-t-butyl-4-hydroxyphenylpropionate), wherein alkyl comprises C1 to C24 carbon atoms, preferably C1 to C20 carbon atoms, particularly preferably C 1 to C18 carbon atoms, ethylene-(bisoxy ethylene)bis-(3,(5-t-butylhydroxy-4-tolyl)-propionate 4,4′-butylidenbis-(6-t-butyl-3-methylphenol) and/or tocopherols such as α-tocopherol, β-tocopherol, γ-tocopherol, δ-tocopherol and their mixtures (vitamin E), preferred are 2,6-di-(t-butyl)-p-cresol (BHT), tetrakis[methylene(3,5-di-t-butyl-4-hydroxyhydrocinnamat)]methane, alkyl-3-(3,5-di-t-butyl-4-hydroxyphenylpropionate), wherein alkyl comprises C1 to C24 carbon atoms, preferably C1 to C20 carbon atoms, particularly preferably C1 to C18 carbon atoms, octadecyl-3-(3,5-di-t-butyl-4-hydroxyphenylpropionate), α-tocopherol, β-tocopherol, γ-tocopherol and/or δ-tocopherol.

Amin-free lactones ii), in particular benzofuranones, are for example described in EP-A 1291384 and DE-A 19618786. Preferred benzofuranones are for example 5,7-di-t-butyl-3-phenyl-benzofurane-2-one, 5,7-di-t-butyl-3-(3,4-dimethylphenyl)-benzofurane-2-one, 5,7-di-t-butyl-3-(2,3-dimethylphenyl)-benzofurane-2-one and/or 5-t-octyl-3-(2-acetyl-5-t-octylphenyl)-benzofurane-2-one.

Antioxidants iii) are for example phosphites and phosphonites. They are for example described in EP-A 905180 and EP-A 1874853, such as triphenylphosphite, diphenylalkylphosphite, phenyldialkylphosphite, tris(nonylphenyl)phosphite, trilaurylphosphite, trioctadecylphosphite, distearylpentaerythritol-diphosphite, tris(2,4-di-t-butylphenyl)phosphite, diisodecylpentaerythritoldiphosphite, bis(2,4-di-t-butylphenyl)pentaerythritoldiphosphite, bis(2,6-di-t-butyl-4-methylphenyl)-pentaerythritol-diphosphite, bisisodecyloxypenta-erythritoldiphosphite, bis(2,4-di-t-butyl-6-methylphenyl)penta-erythritoldiphosphite, bis(2,4,6-tri-t-butylphenyl)pentaerythritoldiphosphite, tristearylsorbitol-triphosphite, tetrakis(2,4-di-t-butylpheny4,4′-biphenylendiphosphonite, 6-isooctyloxy-2,4,8,10-tetra-t-butyl-12H-dibenzo[d,g]-1,3,2-dioxaphosphocine, 6-fluoro-2,4,8,10-tetra-t-butyl-12-methyldibenzo[d,g]-1,3,2-dioxaphosphocine, bis(2,4-di-t-butyl-6-methylphenyl)methyl-phosphite and/or bis(2,4-di-t-butyl-6-methylphenyl)ethylphosphite.

Antioxidants A4.2, which comprise at least one compound with one or more amino groups, are generally secondary amines of the formula (VII)

HNR1R2 (VII),

wherein R1 is C1-C18 alkyl, phenyl-C1-C4-alkyl, C5-C12-cycloalkyl, phenyl, naphthyl, phenyl or naphthyl, each of which being substituted by C1-C12 alkyl or C1-C12 alkoxy or benzyl or a,a-dimethylbenzyl, and R2 is phenyl, naphthyl, phenyl or naphthyl, each of which being substituted by C1-C12 alkyl or C1-C12 alkoxy or benzyl or α,α-dimethylbenzyl.

Suitable antioxidants A4.2 are for example N,N′-di-isopropyl-p-phenylenediamine, N,N′-di-sec-butyl-p-phenylenediamine, N, N′-bis(1,4-dimethyloentyl)-p-phenylenediamine, N, N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluolsulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-t-octylphenyl)-1-naphthylamine, N-phenyl-2-naphthylamine, octylated diphenylamine, for example p,p′-di-t-octyldiphenylamine, 4-n-butylaminophenole, 4-butyrylaminophenole, 4-nonanoylaminophenole, 4-dodecanoylaminophenole, 4-octadecanoylaminophenole, bis(4-methoxyphenyl)amine, 2,6-di-t-butyl-4-dimethylaminomethylphenole, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenylamino)propane, (o-tolyl)biguanide, bis[4-(1′,3′-dimethylbutyl)phenyl]amine, t-octylated N-phenyl-1-naphthylamine, a mixture of mono- and dialkylated t-butyl/t-octyldiphenylamines, a mixture of mono- and dialkylated nonyldiphenylamines, a mixture of mono- and dialkylated dodecyldiphenylamines, a mixture of mono- and dialkylated isopropyl/isohexyldiphenylamines, a mixture of mono- and dialkylated t-butyldiphenylamines, 2,3-dihydro-3,3-dimethyl-4H- 1,4-benzothiazine, phenothiazine, a mixture of mono- and dialkylated t-butyl/t-octylphenothiazines, a mixture of mono- and dialkylated t-octyl-phenothiazines, N-allylphenothiazine and/or N,N,N′,N′-tetraphenyl-1,4-diaminobut-2-ene, preferably a mixture of mono- and dialkylated t-butyl/t-octyldiphenylamines, a mixture of mono- and dialkylated nonyldiphenylamines, a mixture of mono- and dialkylated dodecyldiphenylamines, a mixture of mono- and dialkylated isopropyl/isohexyldiphenylamines, a mixture of mono- and dialkylated t-butyldiphenylamines.

In a preferred embodiment of the method of the invention, the antioxidant A4.1, which is free from amino groups, comprises compounds containing
i) phenolderivatives,
ii) lactones
iii) phosphorusderivatives,
and any mixtures of these compounds, and the antioxidant A4.2 comprises at least one compound with one or more secondary amino groups.

It can further be provided that the antioxidant A4.1 comprises at least one phenol derivate i) and the antioxidant A4.2 comprises at least one compound of the formula

HNR1R2 (VII),

wherein R1 is C1-C18 alkyl, phenyl-C1-C4-alkyl, C5-C12-cycloalkyl, phenyl, naphthyl, phenyl or naphthyl, each of which being substituted by C1-C12 alkyl or C1-C12 alkoxy or benzyl or a,a-dimethylbenzyl, and R2 is phenyl, naphthyl, phenyl or naphthyl, each of which being substituted by C1-C12 alkyl or C1-C12 alkoxy or benzyl or α,α-dimethylbenzyl.

In a further embodiment, antioxidant A4.1 is used in an amount of 0.02-3.0 weight parts, preferably 0.04-2.0 weight parts, particularly preferably 0.05 1.5 weight parts, based on the sum of the weight parts of components A1 and A2, and antioxidant A4.2 is used in an amount of 0.02-3.0 weight parts, preferably 0.04-2.0 weight parts, particularly preferably 0.05-1.5 weight parts, based on the sum of the weight parts of components A1 and A2.

In a further embodiment the method of the invention is carried out in the presence of

A4.1 0.02-3.0 weight parts, preferably 0.04-2.0 weight parts, particularly preferably 0.05-1.5 weight parts, based on the sum of the weight parts of components A1 and A2, at least one compound selected from the group consisting of 2,6-di-(t-butyl)-p-cresol (BHT), tetrakis[methylene(3,5-di-t-butyl-4-hydroxyhydrocinnamat)]methane, 2,2′-methylenebis-(4-methyl-6-t-butylphenole), 2,6-di-t-butyl-4-methylphenole, N,N′-1,6-hexamethylene-bis-3-(3,5-di-t-butyl-4-hydroxyphenyl)propionamide, alkyl-3-(3,5-di-t-butyl-4-hydroxyphenylpropionate), wherein alkyl comprises C1 to C24 carbon atoms, preferably C1 to C20 carbon atoms, particularly preferably C1 to C18 carbon atoms, ethylene-(bisoxyethylene)bis-(3,(5-t-butylhydroxy-4-tolyl)-propionate 4,4′-butylidenebis-(6-t-butyl-3-methylphenole) and/or tocopherols such as α-tocopherol, β-tocopherol, γ-tocopherol, δ-tocopherol and their mixtures (vitamin E), and
A4.2 0.02-3.0 weight parts, preferably 0.04-2.0 weight parts, particularly preferably 0.05-1.5 weight parts, based on the sum of the weight parts of components A1 and A2, at least one compound selected from the group consisting of N,N′-di-isopropyl-p-phenylenediamine, N,N′-di-sec-butyl-p-phenylenediamine, N, N′-bis(1,4-dimethyloentyl)-p-phenylenediamine, N, N′-bis(1-ethyl-3-methylpentyl)-p-phenylenediamine, N,N′-bis (1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluolsulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-t-octylphenyl)-1-naphthylamine, N-phenyl-2-naphthylamine, octylated diphenylamine, for example p,p′-di-t-octyldiphenylamine, 4-n-butylaminophenole, 4-butyrylaminophenole, 4-nonanoylaminophenole, 4-dodecanoylaminophenole, 4-octadecanoylaminophenole, bis(4-methoxyphenyl)amine, 2,6-di-t-butyl-4-dimethylaminomethylphenole, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenylamino)propane, (o-tolyl)biguanide, bis[4-(1′,3′-dimethylbutyl)phenyl]amine, t-octylated N-phenyl-1-naphthylamine, a mixture of mono- and dialkylated t-butyl/t-octyldiphenylamines, a mixture of mono- and dialkylated nonyldiphenylamines, a mixture of mono- and dialkylated dodecyldiphenylamines, a mixture of mono- and dialkylated isopropyl/isohexyldiphenylamines, a mixture of mono- and dialkylated t-butyldiphenylamines, 2,3-dihydro-3,3-dimethyl-4H-1,4-benzothiazine, phenothiazine, a mixture of mono- and dialkylated t-butyl/t-octylphenothiazines, a mixture of mono- and dialkylated t-octyl-phenothiazines, N-allylphenothiazine and/or N,N,N′,N′-tetraphenyl-1,4-diaminobut-2-ene.

In a further embodiment the method of the invention is carried out in the presence of
A4.1 0.02-3.0 weight parts, preferably 0.04-2.0 weight parts, particularly preferably 0.05-1.5 weight parts, based on the sum of the weight parts of components A1 and A2, at least one compound selected from the group consisting of 2,6-di-(t-butyl)-p-cresole (BHT), tetrakis[methylene(3,5-di-t-butyl-4-hydroxyhydrocinnamate)]-methane, alkyl-3-(3,5-di-t-butyl-4-hydroxyphenylpropionate), wherein alkyl comprises C1 to C18 carbon atoms, octadecyl-3-(3,5-di-t-butyl-4-hydroxyphenylpropionate), α-tocopherol, β-tocopherol, γ-tocopherol and/or δ-tocopherol, and
A4.2 0.02-3.0 weight parts, preferably 0.04-2.0 weight parts, particularly preferably 0.05-1.5 weight parts, based on the sum of the weight parts of components A1 and A2, at least one compound selected from the group consisting of mono- and dialkylated t-butyl/tert-octyldiphenylamines, a mixture of mono- and dialkylated nonyldiphenylamines, a mixture of mono- and dialkylated dodecyldiphenylamines, a mixture of mono- and dialkylated isopropyl/isohexyldiphenylamines, a mixture of mono- and dialkylated t-butyldiphenylamines.

Component A5

As component A5, 0 to 10 weight parts of adjuvants and additives are used, in particular 0.1 to 8.0 weight parts, preferably 0.1 to 7.5 weight parts, particularly preferably 0.15 to 7.0 weight parts, respectively based on the sum of the weight parts of components A1 and A2. For example, the following components can be used separately or in any combination as adjuvants or additives according to the method of the invention:
a) catalysts,
b) surface-active additives such as emulsifiers and foam stabilisers, in particular the ones with a low emission, such as products of the Tegostab® LF series,
c) Additives such as reaction retarders (e.g. agents with an acidic reaction such as hydrochloric acid or organic acid halides), cell regulators (such as paraffins or fatty alcohols or dimethylpolysiloxanes), pigments, colouring agents, solid flame retardants (such as melamine and/or ammoniumpolyphosphate), liquid flame retardants (e.g. halogenated, such as tris(2-chloropropyl)phosphate or halogen-free, e.g. on the basis of oligomer phosphates as described e.g. in EP 2687534 and U.S. Pat. No. 4,382,042), further stabilisers against ageing and weather conditions, plasticisers, substances with a fungiastic and bacteriostatic action, fillers (such as barium sulphate, kieselgur, soot chalk or whiting) and separating agents.

These adjuvants and additives which are to be used optionally are for example described in EP-A 0 000 389, pages 18-21. Further examples of adjuvants and additives to be optionally used according to the invention as well as details concerning the use and action of these adjuvants and additives are described in the Kunststoff-Handbuch, volume VII, published by G. Oertel, Carl-Hanser-Verlag, Munich, 3rd edition, 1993, e.g. on pages 104-127.

Preferably, aliphatic tertiary amines (such as trimethylamine, 54rimethylamine, tetramethylbutanediamine), cycloaliphatic tertiary amines (such as 1,4-diaza(2,2,2)bicyclooctane), aliphatic aminoethers (such as dimethylaminoethylethers and N,N,N-tri methyl-N-hy droxy ethyl-bisaminoethylethers), cycloaliphatic aminoethers (such as N-ethylmorpholine), aliphatic amidines, cycloaliphatic amidines, urea, derivates of the urea (such as aminoalkyl ureas, see for example EP-A 0 176 013, in particular (3-dimethylaminopropylamine) urea) and tin catalysts (such as dibutyl tin oxide, dibutyl tin dilaurate, tin(II)-ethylhexanoate, tin ricinoleate) are used as catalysts.

Component B

2,4- and/or 2,6-TDI and/or modified polyisocyanates derived from 2,4- and/or 2,6-TDI or mixtures of these isocyanates with other di- and/or polyisocyanates can be used as di- and/or polyisocyanates in the method according to the invention.

Modified polyisocyanates derived from 2,4- and/or 2,6-TDI shall mean TDI-based polyisocyanates, for example with carbodiimide groups, urethane groups, allophanate groups, isocyanurate groups, urea groups or biurete groups.

“Other” di-and/or polyisocyanates shall be understood as aliphatic, cycloaliphatic, araliphatic, aromatic and heterocyclic di- and/or polyisocyanates as described e.g.

by W. Siefken in Justus Liebigs Annalen der Chemie, 562, pages 75 to 136, for example the ones with the formula (VIII)

Q(NCO)ₙ, (VIII)

wherein

n=2-4, preferably 2-3,

and

Q is an aliphatic hydrocarbon residue with 2-18 carbon atoms, preferably 6-10 carbon atoms, a cycloaliphatic hydrocarbon residue with 4-15 carbon atoms, preferably 6-13 carbon atoms or an araliphatic hydrocarbon residue with 8-15 carbon atoms, preferably 8-13 carbon atoms. For example, these are polyisocyanates as described in EP-A 0 007 502, pages 7-8.

Preferably, 2,4- and/or 2,6-toluylenediisocyanate and/or modified polyisocyanates which are derived from 2,4- and/or 2,6-TDI, 2,4- and/or 2,6-toluylenediisocyanate being particularly preferred, are used as isocyanate component B.

In a further embodiment of the method of the invention, the isocyanate component B comprises a toluylenediisocyanate isomer mixture of 55 to 90 weight % of 2,4- and 10 to 45 weight % of 2,6-TDI.

In a further embodiment of the method of the invention, the index is ≧70 to ≦130, preferably ≧85 to ≦125, ≧90 to ≦120 being particularly preferred. The index indicates the percentage ratio of the amount of isocyanate actually used to the stoichiometric amount, i.e. the amount of isocyanate groups (NCO) calculated for the reaction of the OH equivalents:

index=[used amount of isocyanate):(calculated amount of isocyanate)·100 (IX)

The polyurethane foams, preferably polyurethane soft foams, to be obtained according to the invention, are for example used as: furniture upholstery, textile inlays, mattresses, car seats, headrests, armrests, sponges, foam foils for use in automotive parts such as roof liners, door claddings, seat covers and for construction components.

The viscoelastic polyurethane foams and polyurethane soft foams produced according to the invention typically show low discolouration tendencies during the storage in the air and under the influence of light, in particular UV light.

The soft foams according to the invention have a bulk density according to DIN EN ISO 3386-1 in the range of ≧10 to ≦120 kg/m³, preferably ≧12 to ≦65 kg/m³.

In the following, the present invention will be illustrated by way of exemplary embodiments.

### EXAMPLES

Polyol A1-1: trifunctional polyether carbonate polyol on the basis of glycerin with hydroxyl number 238 mg KOH/g, obtained by copolymerisation of 7 weight % of carbon dioxide with 93 weight % of propylene oxide

Polyol A1-2: trifunctional polyether polyol on the basis of glycerin with hydroxyl number 235 mg KOH/g, obtained by polymerisation of 100 weight % of propylene oxide

Polyol A1-3: trifunctional polyether polyol on the basis of glycerin with hydroxyl number 37 mg KOH/g, obtained by polymerisation of 25 weight % of propylene oxide with 75% of ethylene oxide

Polyol A1-4: trifunctional polyether polyol on the basis of glycerin with hydroxyl number 28 mg KOH/g, obtained by polymerisation of 85 weight % of propylene oxide with 15% of terminal ethylene oxide

Polyol A2-1: trifunctional polyether polyol on the basis of glycerin with hydroxyl number 48 mg KOH/g, obtained by copolymerisation of 10 weight % of ethylene dioxide with 90 weight % of propylene oxide.

A5-1 (stabiliser): siloxane-based foam stabiliser Tegostab® BF 2370, (Evonik Goldschmidt GmbH, Essen)

A5-2 (stabiliser): siloxane-based foam stabiliser Niax® L-626, (Momentive Performance Materials GmbH, Leverkusen)

Isocyanate B1: mixture of 80 weight % 2.4- and 20 weight % 2.6-toluylenediisocyanate, to be obtained under the name Desmodur® T 80, (Covestro Deutschland AG, Leverkusen)

Isocyanate B2: MDI-isomer mixture with a NCO content of 32.0%, to be obtained under the name Desmodur® 10WB94, (Covestro Deutschland AG, Leverkusen)

A5-3 (catalyst): Dabco® NE 300, amine catalyst mixture, (Air Products GmbH, Hamburg)

A5-4 (catalyst): Dabco® NE 500, amine catalyst mixture, (Air Products GmbH, Hamburg)

A5-5 (catalyst): tin(II)-ethylhexanoate, to be obtained as Dabco® T-9, (Air Products GmbH, Hamburg)

A5-6 (catalyst): Addocat 105, amine catalyst (Rhein Chemie Rheinau GmbH, Mannheim)

A5-7 (catalyst): Addocat 108, amine catalyst (Rhein Chemie Rheinau GmbH, Mannheim)

A5-8: (stabiliser): siloxane-based foam stabiliser Tegostab® B 8681, (Evonik Goldschmidt GmbH, Essen)

The hydroxyl number was determined according to DIN 53240.

Polyurethane foams were produced according to the formulas indicated in the following table 1.

The proportions of the components are stated in weight parts.

The bulk density and the compression hardness were determined according to DIN EN ISO 3386-1.

The tensile strength and tensile strength were determined according to DIN EN ISO 1798.

The compression set was determined according to DIN EN ISO 1856.

The ball rebound elasticity was determined according to DIN EN ISO 8307:2007.

TABLE 1
Polyurethane soft foams

| | Example | | | | | |
|---|---|---|---|---|---|---|
| | 1 | 2 | 3 (cf.) | 4 (cf.) | 5 (cf.) | 6 (cf.) |
| A1-1 | 60 | 60 | | | 44 | |
| A1-2 | | | 60 | 60 | | 44 |
| A1-3 | | | | | 33 | 33 |
| A1-4 | | | | | 23 | 23 |
| A2-1 | 40 | 40 | 40 | 40 | | |
| A5-1 | 0.40 | 0.40 | 0.40 | 0.40 | | |
| A5-2 | 0.80 | 0.80 | 0.80 | 0.80 | | |
| A5-3 | 0.20 | 0.20 | 0.20 | 0.20 | | |
| A5-4 | 0.40 | 0.40 | 0.40 | 0.40 | | |
| A5-5 | 0.02 | 0.02 | 0.02 | 0.02 | | |
| A5-6 | | | | | 0.35 | 0.35 |
| A5-7 | | | | | 0.16 | 0.16 |
| A5-8 | | | | | 0.20 | 0.20 |
| A3 (water) | 1.70 | 1.70 | 1.70 | 1.70 | 2.00 | 2.00 |
| Isocyanate B1 | 37.6 | 41.8 | 37.4 | 41.5 | | |
| Isocyanate B2 | | | | | 46.70 | 46.20 |
| NCO index | 90 | 100 | 90 | 100 | 80 | 80 |
| Bulk density [kg m⁻³] | 54 | 51.8 | 52.3 | 53.6 | | 49.2 |
| Compression hardness at | 1.60 | 3.99 | 1.81 | 41.8 | | 1.96 |
| 40% deformation [kPa] | | | | | | |
| Tensile strength [kPa] | 83 | 171 | 60 | 127 | | 45 |
| Elongation at break [%] | 235 | 180 | 182 | 169 | | 124 |
| Compression set at 50% | 2.6 | 1.6 | 2.6 | 1.5 | | 1.4 |
| deformation [%] | | | | | | |
| ball rebound elasticity | 7 | 10 | 6 | 10 | | 14 |
| according to DIN EN | | | | | | |
| ISO 8307:2007 [%] | | | | | | |
| Note | | | | | Foam | |
| | | | | | collapse | |

Examples 1 and 2 are examples according to the invention, examples 3 and 4 are comparative examples. The results show that the inventive use of polyether carbonate polyols and an otherwise identical formula with the same NCO index results in foams with a slightly reduced compression hardness which have better mechanical characteristics, in particular with regard to tensile strength and elongation at break, than the comparative foams according to examples 3 and 4. Examples 5 and 6 are also comparative examples. They show that the polyurethane foams based on polyether carbonate polyol according to the invention can only be obtained by using TDI or TDI based polyisocyanates, but not by using pure MDI, for example.

1. A method for the production of viscoelastic polyurethane foams comprising reacting a component A with a component B, wherein component A comprises:
A1 ≧50 to ≦100 parts by weight of at least one polyether carbonate polyol with a hydroxyl number from ≧150 mg KOH/g to ≦300 mg KOH/g according to DIN 53240,
A2 ≦50 to ≧0 parts by weight parts of at least one polyether poly with a hydroxyl number from ≧20 mg KOH//g to ≦250 mg KOH/g according to DIN 53240, wherein the polyether polyol is free from carbonate units,
A3 0.5 to 25 parts by weight, based on the sum of the parts by weight of components A1 and A2, of water and/or physical propellants,
A4 0 to 10 parts by weights, based on the sum of the parts by weight of components A1 and A2, of at least one antioxidant,
A5 0 to 10 parts by weight, based on the sum of the parts by weight of components A1 and A2, of adjuvants and/or additives; component B comprises:
B at least one di- and/or polyisocyanate, comprising 2,4-toluene diisocyanate, 2,6-toluene diisoevanate, modified polyisocyanates derived from 2,4-toluene diisocyanate modified polyisocyanates derived from 2,6-toluene diisocyanate, mixtures thereof, or mixtures of these isocyanates with other di- and/or polyisocyanates,
wherein the reaction of component A with component B is carried out at an isocyanate index of 70 to 130 and wherein the sum of the parts by weight of A1+A2 is 100 parts by weight in the composition.

2. The method according to claim 1, wherein A comprises ≧55 to ≦100 weight parts of the polyether carbonate polyol A1 and ≦45 to ≧0 weight parts of the polyether polyol A2.

3. The method according to claim 1, wherein A comprises 100 parts by weight of A1, 0 parts by weight of A2 and is free of other organic polyols.

4. The method according to claim 1, wherein polyether carbonate polyol A1 has a hydroxyl number according to DIN 53240 of >250 mg KOH/g to ≦300 mg KOH/g.

5. The method according to clam 1, wherein polyether carbonate polyol A1 has an average OH functionality of 2.5 to 3.5.

6. The method according to claim 1, wherein polyether carbonate polyol A1 can be obtained by copolymensation of ≧2 weight % to ≦30 weight % of carbon dioxide and ≧70 weight % to ≦98 weight % of one or more alkylene oxides in the presence of one or more H-functional starter molecules with an average functionality of ≧1 to ≦6, wherein said polyether carbonate polyol A1 can be obtained in the presence of a multi metal cyanide catalyst or a double metal cyanide catalyst.

7. The method according to claim 1, wherein said polyether carbonate polyol A1 can be obtained from one or more alkylene oxides comprising ethylene oxide and/or propylene oxide.

8. The method according to claim 1, wherein said polyether carbonate polyol A1 comprises blocks e and f which correspond to formula (I) in which the ratio e/f ranges from 2:1 to 1:20.

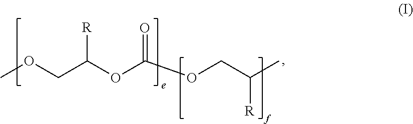

9. The method according to claim 1, wherein the resultant viscoelastic polyurethane foam is a polyurethane soft foam which is characterized by a ball rebound elasticity according to DIN EN ISO 8307:2007 of 10% to 20%.

10. The method according to claim 1, wherein component A4 comprises A4.1 comprising 0.02-5.0 parts by weight, based on the sum of the parts by weight of components A1 and A2, of an antioxidant which is free from amino groups, and component A4.2, comprising 0.02-5.0 parts by weight, based on the sum of the parts by weight of components A1 and A2, of an antioxidant which comprises at least one compound with one or more amino groups, wherein the total content of component A4 is 0.04-10.0 parts by weight, based on the sum of the parts by weights of components A1 and A2,

11. The method according to claim 10, wherein said antioxidant A4.1 is selected from the eroup consisting of i) phenol derivatives, ii) lactones, iii) phosphorus derivatives and iv) mixtures of these compounds, and said antioxidant A4.2 comprises at least one compound with one or more secondary ammo groups.

12. The method according to claim 1, wherein component B comprises 2,4-toluene diisocyanate, 2,6-toluene diisocyanate, and/or modified polyisocyanates which are derived from 2,4-toluene diisocyanate modified polyisocyanate which are derived from 2,6-toluene diisocyanate or mixtures thereof,

13. A polyurethane soft foam obtained by the method according to claim 1.

14. An article comprising the polyurethane soft foam according to claim 13 in furniture, textile, bedding, automotive and/or construction industries.

15. A process of producing a viscoelastic polyurethane comprising reacting a di- or polyisocyanate component with an isocyanate-reactive component, wherein said isocyanate-reactive component comprises a polyol component comprising ≧50 to <100 parts by weight of at least one polyether carbonate polyol A1 with a hydroxyl number according to DIN 53240 of ≧150 mg KOH/g to ≦300 mg KOH/g, and ≦50 to ≧0 parts by weight of at least one polyether polyol A2 with a hydroxyl number according to DIN 53240 of ≧20 rag KOH/g to ≦2.50 mg KOH/g, free from carbonate units.
